(19) United States
(12) Patent Application Publication
(10) Pub. No.: US 2008/0249347 A1
(43) Pub. Date: Oct. 9, 2008

(54) Waste Stabilization and Packaging System for Fissile Isotope-Laden Wastes

(76) Inventors: William Gregory Broda, Knoxville, TX (US); Stanley M. Hodges, Lexington, SC (US)

Correspondence Address: HOLLAND & HART LLP, 60 E. South Temple, Suite 2000, P.O. Box 11583, Salt Lake City, UT, 84110, US

(21) Appl. No.: 11/696,444

(22) Filed: Apr. 4, 2007

(51) Int. Cl. G21F 9/16

(52) U.S. Cl. 588/3

(57) ABSTRACT

A method for shredding, blending, and packaging wastes so that the shipment of waste is acceptable for transportation and disposal. Containerized wastes, laden with fissile isotopes, such as that from sodium fluoride traps and granulated carbon collection assemblies, if not already conditioned, are conditioned for blending by shredding them to particle size and then blending the particles with a grout mix either in a reusable mixing vessel or in a disposable mixing vessel. The blend of waste and grout is selected to meet governmental and disposal site requirements for an acceptable waste shipment. If blended in a reusable vessel, the blended waste is transferred to shipping containers. The shipping containers are placed in shielded shipping casks for transportation to a disposal facility. The grout mix is a combination of grout and neutron poisons such as borated sand to prevent criticality.

### CROSS REFERENCE TO RELATED PATENTS

Not applicable

### BACKGROUND OF THE INVENTION

The present invention relates to the stabilization, transportation and disposal of certain types of radioactive wastes, such as fissile isotope-laden wastes and to uranium-laden wastes in particular.

Handling, transporting and disposing of fissile isotope-laden wastes present special issues. This type of waste, for example, is accumulated in granulated charcoal collection assemblies and sodium fluoride traps from sources that contain U-233, a fissile isotope of uranium. Fissile uranium-laden wastes raise a concern about criticality from presence of fissile isotopes and about radioactivity from their daughter-products. These wastes require remote handling in order to protect workers.

Currently, these wastes are stored near the point of generation. Existing processes for preparing them for more permanent storage or final disposition are expensive, so the wastes are accumulated in storage containers while they await a more acceptable long-term solution. To be acceptable, such a solution would allow the waste to be processed safely into a form that is stable for transportation and disposal at a permanent disposal site. Furthermore, the stabilizing process must assure that criticality is not possible and radiation exposure is within acceptable limits.

Currently, the only known way to handle these wastes is an expensive one, in which the uranium is extracted but which leaves the balance of the waste for separate processing. So, in addition to high cost, the prior art solution is at best a partial solution.

In addition to fissile isotope-laden wastes, there are other wastes being stored while awaiting an effective long-term solution. Many of these problematic wastes are legacy wastes from government processing in the latter half of the 20^{th} century. Some resulted from inadvertent actions and others are the result of routine operations. Although the solutions for low-level radioactive waste and for chemical waste are clear, the solution for mixed radioactive and chemical wastes is not. They cannot be disposed of in radioactive waste disposal sites or in chemical waste disposal sites. Similarly, mixing fissile isotopes with low-level radioactive wastes dramatically limits the disposal options.

Thus there remains a need for a better solution for the treatment and disposal of fissile isotope-laden wastes and for a better approach to the treatment and disposal of other types of problematic wastes.

### SUMMARY OF THE INVENTION

According to its major aspects and briefly recited, the present invention is a system and method for remotely conditioning, stabilizing, and packaging wastes for transportation and disposal. Once the wastes have been packaged, they are handled in a manner similar to other radioactive wastes in terms of their transportation and disposal because they present no issues different from those presented by ordinary radioactive wastes; that is, they pose no concern for criticality and are no different from other radioactive waste shipments from a radioactivity standpoint.

The present process begins by either obtaining conditioned wastes or by conditioning the wastes at the outset. If the wastes are in a flowable form, that is, they are in the form of particles or liquids, they are in proper condition for the next step, the blending step. If they are not, or, in particular, if the waste is in containers with internal structures that are solid rather than in the form of particles (such as filters, for example), the waste may be conditioned by shredding. Shredding can be done using low-speed, high-torque shredders. Shredding releases the contents of the containers and traps, and reduces the waste to particles. Because the containers are shredded along with the wastes, secondary waste handling requirements are eliminated and processing is quicker.

The conditioned wastes are then transferred to a mixing vessel where precisely determined amounts of the waste are mixed with grout and stabilizing agents. The mixing vessel is partially filled with waste which is carefully metered. Then the grout mix is added while sensors monitor the level in the mixing vessel to prevent overfilling. The vessel, fifted with mixing impellers, homogeneously blends the wastes and grout mix as they are added. Off-gas from the shredder and mixing vessel is collected during the conditioning and blending steps by placing the system under a slight vacuum and passing the collected gas through a high efficiency particulate air (HEPA) ventilation system to collect particulate.

The blended wastes may then be transferred to disposable shipping containers, such as 55-gallon drums for example, which are placed in shielded shipping casks for transportation to an appropriate disposal site. Alternatively, the mixing vessel itself may be a large disposable steel liner that fits directly into the shipping cask.

Government transportation requirements on fissile material and disposal site waste acceptance requirements limit the shipment to not more than 1 gram of U-235 Fissile Gram Equivalent (FGE) material in 2000 grams of non-fissile material, and not more than 180 grams of U-235 FGE material within any 360 kg segment of contiguous material. The Nevada Test Site Waste Acceptance Criteria require a shipment to have not more than 350 grams of U235 FGE in one package and not more than 2 grams U-235 FGE per kilogram of non-fissile mass. For shipping containers that are drums, the transportation requirements are the limiting factor; for larger containers the Nevada Test Site limits are the limiting factor.

Regardless of the choice of container, the stabilized composition and container payload have been designed to meet federal transportation requirements and disposal site waste acceptance criteria on the concentration of fissile content and radiation exposure. Those requirements are established to preclude criticality and prevent overexposure of workers and others. Indeed, for added assurance, a non-destructive analysis of a statistically significant number of drums or liners is performed to verify compliance with criticality requirements and to provide qualitative data for use as part of the certification package accompanying the shipment.

An important feature of the present invention is that conditioned fissile isotope-laden wastes, potentially along with their storage containers, can be blended with grout. If the wastes are not already conditioned, they can be conditioned, such as by shredding, so that they can be incorporated with grout. The shredding not only prepares the waste for blending but simplifies handling of secondary wastes, leaving no waste behind awaiting another solution. All wastes are disposed of.

Another important feature of the present invention is the use of careful metering of the wastes in combination with blending so that the concentration and distribution of the waste will meet governmental requirements for transportation and disposal.

Still another feature of the present invention is the use of grout to stabilize the waste. Stabilizing radioactive wastes with grout is a well known technology for stabilizing low level radioactive waste. Here, grout stabilization, in addition to being known widely accepted, provides the additional advantage of spatially separating and fixing the fissile isotopes in place so that criticality is precluded. It also provides self-sheilding for the waste.

These and other features and their advantages will be apparent to those skilled in the art of waste processing from a careful reading of the Detailed Description of Preferred Embodiments accompanied by the following drawings.

### BRIEF DESCRIPTION OF THE SEVERAL VIEWS OF THE DRAWINGS

In the drawings,

FIG. 1 is flow chart illustrating the present method for processing and packaging uranium-laden wastes, according to a preferred embodiment of the present invention;

FIG. 2 is a schematic illustration of the system for processing and packaging fissile isotope-laden wastes, according to a preferred embodiment of the invention;

FIG. 3 is to top view of the processing system, according to a preferred embodiment of the present invention; and

FIG. 4 is a side view of the processing system, according to a preferred embodiment of the present invention.

### DETAILED DESCRIPTION OF THE INVENTION

The present process and system are designed for specific types of fissile isotope-laden waste and, after application of the process using the system, will result in a form that meets criticality-precluding requirements for transportation and disposal, as well as meeting requirements to avoid unnecessary exposure of workers to radiation. It is also to provide an acceptable waste form for shipment. The present invention is illustrated with a particular type of waste, namely sodium fluoride trap waste and granulated carbon waste, produced in government processing facilities, and which waste contains U-233, a fissile isotope, and other radioactive isotopes. The present process, however, is readily adaptable for use with other problematic wastes, particularly those that use that contain fissile isotopes, including U-233 and 235, and plutonium 239 and 241.

In the following description, several different types of containers are described, including storage containers, disposable shipping containers, mixing vessels and shipping casks. Storage containers are used for temporarily storing the waste to be processed. Disposable shipping containers are used for holding the wastes after they are blended with a grout mix. Shipping containers are the containers the waste/grout mixture remains in for both shipping and disposal. There are also shipping casks that are reusable and serve as portable shielding for the shipping containers, if needed, until the shipping containers are received at a disposal site. Finally, there are reusable mixing vessels that are used for blending waste and grout, and there are also disposable mixing vessels that serve as both mixing vessels and disposable shipping containers.

The term Fissile Gram Equivalent is used herein in reference to requirements imposed by governments for transporting wastes or accepting wastes for disposal when those wastes contain fissile radionuclides, that is, for an acceptable waste shipment. For convenience, various fissile isotopes are compared to a reference fissile isotope, typically U-235. Thus, the standards are expressed in terms of levels of fissile radionuclides not in excess of some limit of grams of U-235 Fissile Gram Equivalent (FGE). In the Nevada Test Site Waste Acceptance Criteria, incorporated herein in its entirety, but recited specifically at pages E9-E13, there is an explanation as to how to determine the U-235 FGE value for given fissile isotopes.

There are two concerns with fissile isotope-laden waste such as the sodium fluoride trap wastes and granulated carbon wastes containing U-233. One concern is radioactivity, due to radioactive daughter products, such as TI-208 and U-232 in the case of U-233-laden wastes. This problem is addressed in the present process by remote handling and the use of shielding, including shielding during transportation. Remote handling, behind shielding and the use of machinery that can handle the waste at a distance, such as telerobotic devices, limits radiation exposure of workers during processing. During transportation, use of shielded shipping casks protects drivers of the tractors hauling the shipping containers and passengers traveling in other vehicles on the same road. As an example of the radioactivity emitted by this type of waste, a granulated charcoal canister may have an estimated surface dose rate greater than 400 R/hour. While being stored, each canister is kept behind 22 inches of concrete for shielding (shipping casks use a combination of lead and steel for shielding, which is a more effective attenuator of radiation per inch thickness of material).

The other concern is criticality. Fissile isotopes such as U-233 and 235 and plutonium 239 and 241 in sufficient amounts can sustain a nuclear chain reaction, that is, the fission of each fissile radionuclide causes on average one fission of another fissile radionuclide. The amount of each type of fissile isotope that sustains a chain reaction is called a critical mass, which varies in amount with each fissile isotope and its environment. When a critical mass or more is assembled, energy, usually in the form of heat and blast is given off, nearly instantaneously. Thus, avoiding criticality is also a significant issue.

The need to protect workers from radiation generally requires that the radiation be attenuated by a combination of shielding and distance. Avoiding criticality, on the other hand, requires either avoiding the assembling of a critical mass of the fissile isotope or the interception of enough neutrons before they cause fissions so that criticality cannot be achieved despite the existence of a critical mass. The present process produces a stable waste form in a manner and under circumstances that addresses both criticality concerns and also mitigates exposure by homogeneous blending of the waste with non-radioactive materials to disperse it, solidify it in place, and to act as shielding. For example, the storage containers containing trap wastes might typically have surface radiation readings of 400 R/hr. Contact exposure with the waste in, for example, 55-gallon shipping container drums after blending with grout and curing, is expected to not exceed 2 R/hr, assuming approximately 7.5 Curies per drum. Moreover, the shipping casks provide considerable additional shielding of the radiation emanating from the shipping containers.

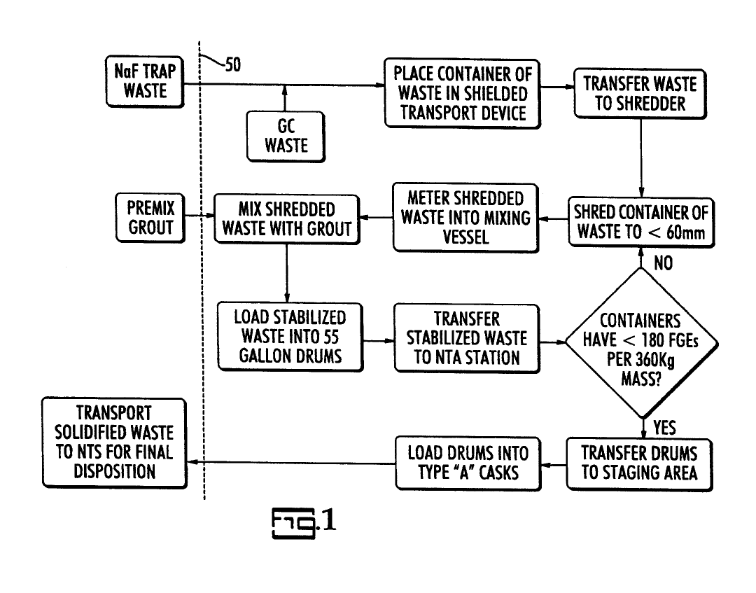

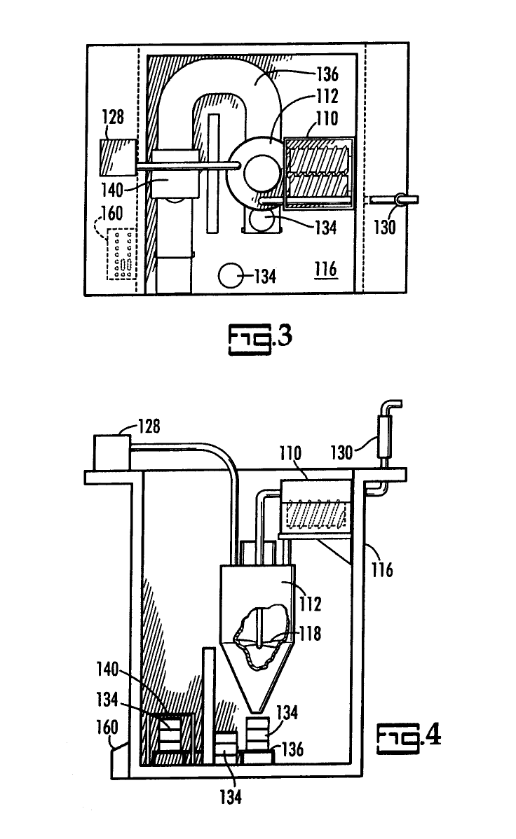

Referring now to FIGS. 1-4, the present process begins by conditioning the waste if it is not already conditioned. The waste is conditioned by preparing it for processing in subsequent steps, in particular, for the blending step. Waste is conditioned if it is blendable, that is, is in a liquid or a particulate form so that it can easily be blended with other liquids or particles. The waste may be in storage containers that may be reusable by the generator of the waste, in which case, the containers do not need to be conditioned. However, if the containers are contaminated and need to be disposed of, optionally, they can be conditioned by shredding, which can simplify handling. If the waste is a form wherein it requires conditioning, shredding is the conditioning method of choice, as it lends itself to remote handling.

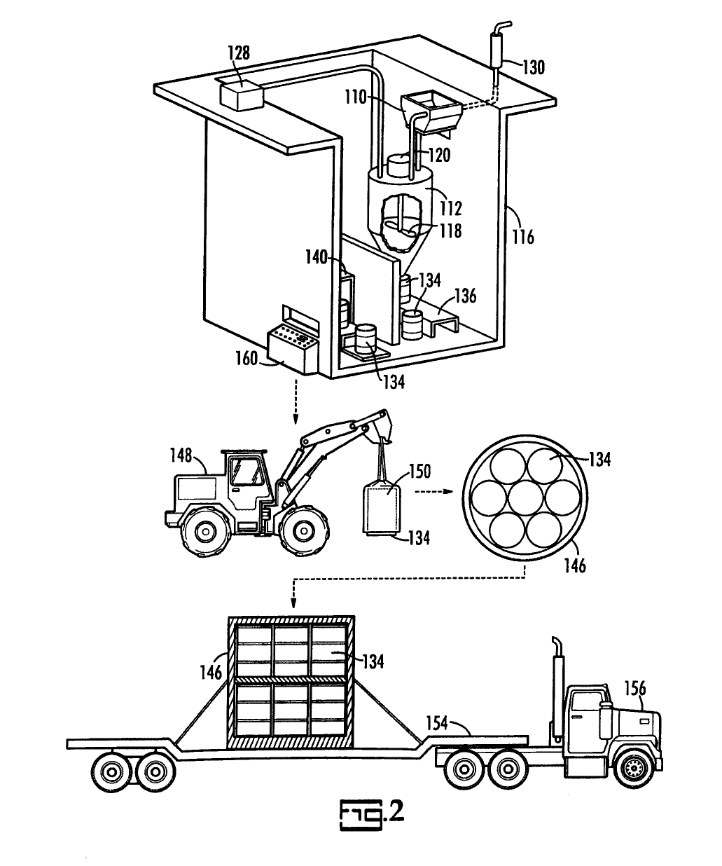

Specifically in the case of the waste in the present example, the waste, namely, sodium trap waste and granulated carbon waste, is typically stored in storage containers, is transferred from storage inside a shielded transport device to a shredder 110 (see FIGS. 2-4). The waste, including the storage container, is shredded into particles in order to blend it with other materials. Shredder 110 is preferably a low-speed, high-torque shredder operated remotely to shred the storage container (such as a granulated carbon assembly or sodium fluoride trap) and its waste contents to particle size, preferably to particles less than 60 mm in size. The shredded wastes are then metered into a mixing vessel 112 for the blending. All components are preferably located within a shielded enclosure 116 to protect workers.

The interior of mixing vessel 112 is fitted in advance with an impeller 118 driven by an external motor 120. The waste is then carefully metered into mixing vessel 112 and then loaded with a premix of grout and perhaps neutron poisons such as boron, preferably in the form of borated sand, transferred from a source 128 of the premix. Impeller 118 mixes the waste/grout mixture thoroughly.

The containers 34 of waste may be transferred by conveyor 136 to a non-destructive analysis (NDA) station 140 for qualitative verification that the waste will meet transportation and disposal site requirements. The analysis is based on characteristic gamma ray signatures, such as that of the TI-208 radionuclide when the fissile isotope is U-233, detected by a sodium iodide crystal or hydrogen-phosphorus-germanium crystal, correlated with benchmark test results to determine qualitatively whether the amount of waste metered into each container 34 does not exceed the limits for transportation and disposal. This optional step may take place after waste is deposited into the shipping container 34 and before grout is added.

If the waste metered into shipping containers 34 is determined to be the appropriate amount, a premix of grout can be then added. Sensors (not shown) monitor the level of the contents of mixing vessel 112 to prevent overfilling. Overfilling is prevented using visual inspection with closed circuit television combined with ultrasonic level control monitors or a high level float switch or any of these in combination are used to monitor the level of waste and grout in mixing vessel 112 and in the shipping containers 34.

The specific formula for the grout premix will depend to a limited extent on the precise nature of the waste. Typically, about 1 gram of Portland Type I cement is used with 0.45 grams of water. This ratio would be adjusted, for example, in consideration of various characteristics of the waste, such as the presence of heavy metals, to meet varying requirements for leach indices for different isotopes present in the waste, and to meet pH leachate requirements. Therefore, a modest amount of experimentation is helpful in producing a stabile monolithic waste form. Because of widespread industry experience with grout as a stabilizing medium for low-level radioactive waste, there is ample prior art on grout formulas for waste constituents.

In addition to producing a stable waste form and doing so efficiently, additional grout may be added to meet transportation and disposal requirements related to the ratios of fissile to non-fissile mass that are imposed by appropriate governmental authorities at the time.

Blending the waste and the grout mix homogeneously separates the fissile isotopes and, upon the curing of the grout, they are held immobilized in that spatial relationship that precludes criticality. A sodium fluoride trap may contain 1000 grams U-235 FGE and a granulated carbon assembly may contain approximately 4700 grams U-235 FGE, of the isotope U-233, so ample grout mix is required to reduce the concentration of fissile grams equivalent in the disposable shipping containers to less than the transportation limits imposed by government authorities.

During the process, the system is subject to a slight negative pressure or vacuum. The off-gas that is collected using this vacuum is passed through a high energy particulate absorber (HEPA) ventilation system 130 so that no airborne radioactive materials escape.

The blended waste may be loaded into disposal containers 134, such as 55-gallon drums, for example, as shown in FIGS. 2-4, carried on a conveyor 136, prior to curing. It is allowed to cure in the shipping containers to a stabilized, solid monolithic form before it is shipped so as to prevent subjecting the waste to vibration until after the chemical bonds are fully set. Alternatively, the mixing vessel 112, rather than being a reusable vessel, can be a disposable vessel, such as a steel liner, fifted with a mixing impeller turned by an external motor for blending the grout mix and waste, and thus use to cure in situ the shredded waste and grout mix. The liner, as a mixing and disposable vessel 112, is transported to a disposal site and disposed of in the same manner as the drums.

If the waste is transferred to drums, the drums are placed in shielded shipping casks 146 using a lifting device 148 and portable shielding 150 to protect workers until containers 134 are fully loaded inside the cask 146. A typical type “A” shipping cask will conveniently hold 14 55-gallon drums in two layers of seven barrels each, one center drum and six surrounding drums. The Type-A cask can be hauled on a trailer 154 pulled by a tractor 156. If the waste is mixed in a large liner, the liner may fit by itself into a shipping cask. For example, a 210 cubic foot liner serving as a disposable container can also fit in a Type-A shipping cask and has approximately 185 cubic feet of usable space with an impeller in place. Other shipping container and cask combinations may also be suitable for use with the present method

The stabilized and blended composition and container have been selected to meet governmental requirements, namely those under the Department of Transportation for shipment of fissile material, and by the Nevada Test Site in its Waste Acceptance Critieria to allow them to be transported and disposed. In particular, the level of fissile material blended with grout mix and transferred into a shipping container does not pose a criticality issue. Those levels are currently established at less than 1 U-235 FGE per 2000 gms of non-fissile material and not more than 180 gms U-235 FGE within 360 Kg of continuous non-fissile material. In addition, the Nevada Test Site waste acceptance criteria requires not more than 350 gms U-235 FGE per container. The shipping containers 34 are transferred to the staging area where they await loading into type A casks for transport of the solidified wastes to the Nevada Test Site for final disposal.

The materials (sodium fluoride waste, granulated carbon and premix grout) are brought into the processing facility where the present method takes place, as indicated by line 50 on FIG. 1; stabilized waste is moved out of the facility 50. Within the facility 50, shredding, blending, loading and curing of the waste in shipping containers and then placement into casks takes place.

The use of grout helps to stabilize the waste by immobilizing the homogenous blend of grout and fissile isotopes. In addition, neutron poisons, such as boron in the form of borated sand, which absorbs neutrons emitted by fissioning radionuclides that might otherwise cause subsequent fission events, may be added to the grout prior to blending with the waste.

The operation takes place in an enclosure 116 to protect workers who control the present process from control station 160, which is operatively connected to shredder 110, mixing vessel 112, mixing motor 120, valves (not shown), the level sensors (not shown), and analysis station 140.

It is intended that the scope of the present invention includes all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art from the foregoing description of the preferred embodiments without departing from the spirit or scope of the present invention.

What is claimed is:

1. A method for processing radioactive wastes containing fissile radionuclides, said method comprising the steps of:
(a) conditioning radioactive wastes;
(b) blending said particles with grout to form a homogeneous mixture in which not more than 1 gram fissile gram equivalent are present in a mass of 2000 grams of said mixture; and
(c) curing said mixture so that said homogenous mixture is solidified.

2. The method as recited in claim 1, wherein said blending step further comprises blending waste containing approximately 1 gram U-235 FGE with 2000 grams of said grout.

3. The method as recited in claim 1, wherein said radioactive wastes are stored in a storage container and said conditioning step includes shredding said storage container of radioactive wastes so that said particles include particles of said storage container.

4. The method as recited in claim 1, further comprises the step of adding neutron poisons to said grout prior to said blending step.

5. The method as recited in claim 1, further comprising the step of loading said cured radioactive waste into a shipping cask.

6. A method of processing radioactive wastes containing fissile isotopes, said method comprising the steps of:
(a) providing wastes containing fissile isotopes;
(b) blending said wastes with a grout mix to form a homogeneous mixture in which not more than 1 gram fissile material is present per 2000 grams of said grout mix; and
(c) curing said mixture so that said homogenous mixture is solidified.

7. The method as recited in claim 6, wherein said homogeneous mixture is transferred to a disposable shipping container prior to said curing step.

8. The method as recited in claim 7, wherein said homogeneous mixture is transferred to 55-gallon drums.

9. The method as recited in claim 6, wherein said providing step further comprises the step of shredding said waste to particles of less than 60 mm in size before said blending step.

10. The method as recited in claim 6, wherein said blending step takes place in a shipping container.

11. The method as recited in claim 6, further comprising the step of mixing a neutron poison with said grout mix before said blending step.

12. The method as recited in claim 6, further comprising the step of mixing borated sand with said grout mix before said blending step.

13. The method as recited in claim 6, further comprising the step of monitoring said cured waste to verify that said waste includes fewer than 1 gram U-235 FGE per 2000 grams of grout mix.

14. An acceptable waste shipment made by the process comprising the steps of:
providing fissile isotope-laden waste in a condition for blending;
blending said fissile isotope-laden waste with a grout mix to form a mixture wherein not more than one gram U-235 FGE is mixed with 2000 grams grout mix; and
curing said mixture in a shipping container.

15. The acceptable waste shipment as recited in claim 14, further comprising the step of conditioning said fissile isotope-laden waste by shredding said waste.

16. The acceptable waste shipment as recited in claim 14, further comprising the step of transferring not more than 350 grams U-235 FGE into said shipping container.

17. The acceptable waste shipment as recited in claim 14, wherein said blending step takes place in said shipping container.

18. The acceptable waste shipment as recited in claim 14, further comprising the step of placing said shipping container in a shipping cask.

19. The acceptable waste shipment as recited in claim 14, further comprising the step of adding a neutron poison to said grout mix prior to said blending step.

20. The acceptable waste shipment as recited in claim 14, further comprising the step of adding borated sand to said grout mix prior to said blending step.
